(19) United States
(12) Patent Application Publication
(10) Pub. No.: US 2019/0255979 A1
(43) Pub. Date: Aug. 22, 2019

(54) RECLINER RETENTION RING AND METHOD OF MAKING THE SAME

(71) Applicant: LEAR CORPORATION, Southfield, MI (US)

(72) Inventors: Brian ZAHN, Plymouth, MI (US); Dale LAMMERS, Plymouth, MI (US); Jose Manuel OTERO CANABAL, Vigo (ES)

(21) Appl. No.: 15/902,296

(22) Filed: Feb. 22, 2018

(51) Int. Cl. B60N 2/90; B60N 2/20

(52) U.S. Cl. CPC B60N 2/933; B21D 7/00; B60N 2/20

(57) ABSTRACT

A retention ring for use with a recliner assembly is provided. The retention ring may be a metal member bent into an annular shape. The metal member may have a first end and a second end that are connected to one another to form a band that defines an inner diameter that may be configured to receive a recliner gear set.

### TECHNICAL FIELD

The present disclosure relates to a recliner mechanism that may be provided with a seat.

### BACKGROUND

A vehicle seat and a recliner assembly is disclosed in U.S. Patent Publication No. 2015/0321585.

### SUMMARY

According to one embodiment of this disclosure, a retention ring for use with a recliner assembly is provided. The retention ring may be a metal member bent into an annular shape. The metal member may have a first end and a second end that are connected to one another to form a band that defines an inner diameter that may be configured to receive a recliner gear set.

According to another embodiment of this disclosure, a method of producing a recliner retention ring for use with a recliner assembly is provided. The method may include bending an elongated metal member, having a first end and a second end, into an annular shape. The method may also include connecting the first end and the second end to one another to form a band that defines an inner periphery configured to receive a recliner gear set.

According to yet another embodiment of this disclosure, a recliner assembly for a vehicle seat including a seat base and a seat back is provided. The recliner assembly includes a retention ring formed by bending an elongated steel member into an annular shape having a first end and a second end. The retention ring may further include a weld that connects the first end and the second end.

### BRIEF DESCRIPTION OF THE DRAWINGS

FIG. 1 is a perspective view of a portion of a seat assembly having a recliner mechanism.

FIG. 2 is an exploded view of the recliner mechanism that specifically includes a retention ring.

FIG. 2A is a perspective view of the retention ring.

FIG. 3 is a flowchart illustrating a method of producing the retention ring according to a first embodiment.

FIG. 4 is a progressive-perspective view of the retention ring produced by the method according to the first embodiment.

FIGS. 4A-4B are cross-sectional detail views of certain steps involved in the method according to a first embodiment

FIG. 5 is a flowchart illustrating a method of producing the retention ring according to a second embodiment.

FIG. 6 is a progressive-perspective view of the retention ring produced by the method according to a second embodiment.

FIG. 7 is a flowchart illustrating a method of producing the retention ring according to a third embodiment.

FIG. 8 is a progressive-perspective view of the retention ring produced by the method according to the third embodiment.

FIG. 8A is a cross-sectional detail view of one of the forming operations according to the third embodiment.

### DETAILED DESCRIPTION

As required, detailed embodiments are disclosed herein; however, it is to be understood that the disclosed embodiments are merely exemplary and that various and alternative forms may be employed. The figures are not necessarily to scale; some features may be exaggerated or minimized to show details of particular components. Therefore, specific structural and functional details disclosed herein are not to be interpreted as limiting, but merely as a representative basis for teaching one skilled in the art.

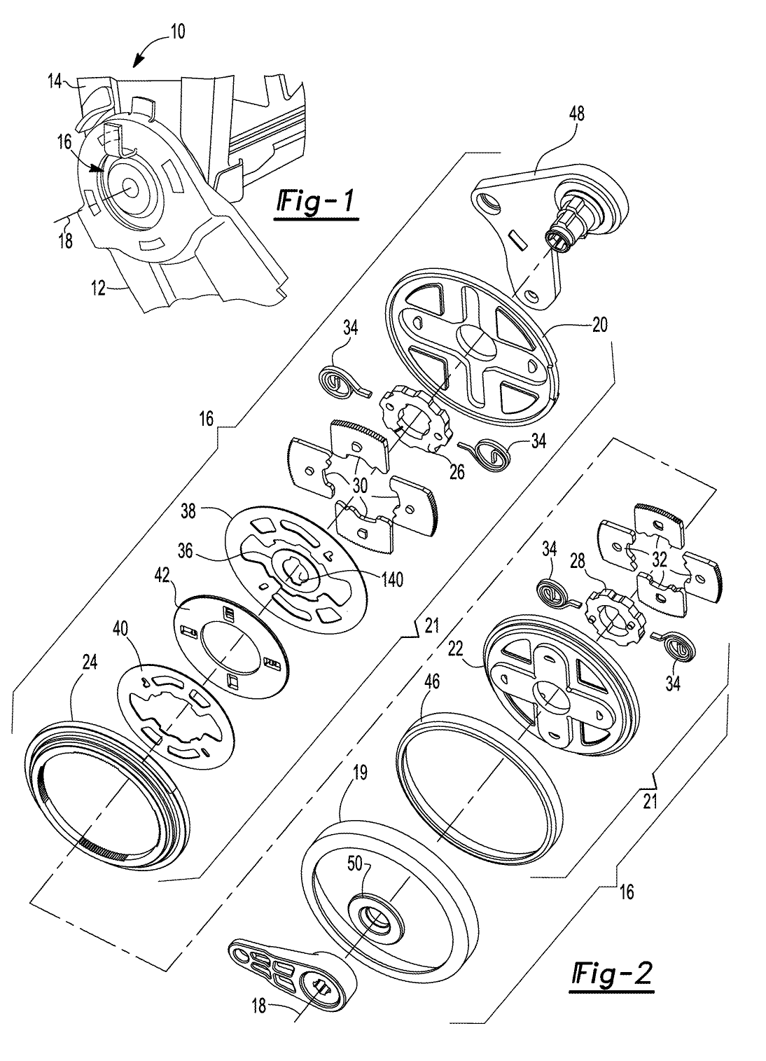

Referring to FIG. 1, a portion of a seat assembly 10 is shown. The seat assembly 10 may have a seat bottom 12, a seat back 14, and a recliner assembly 16 connected to the seat bottom 12 and the seat back 14.

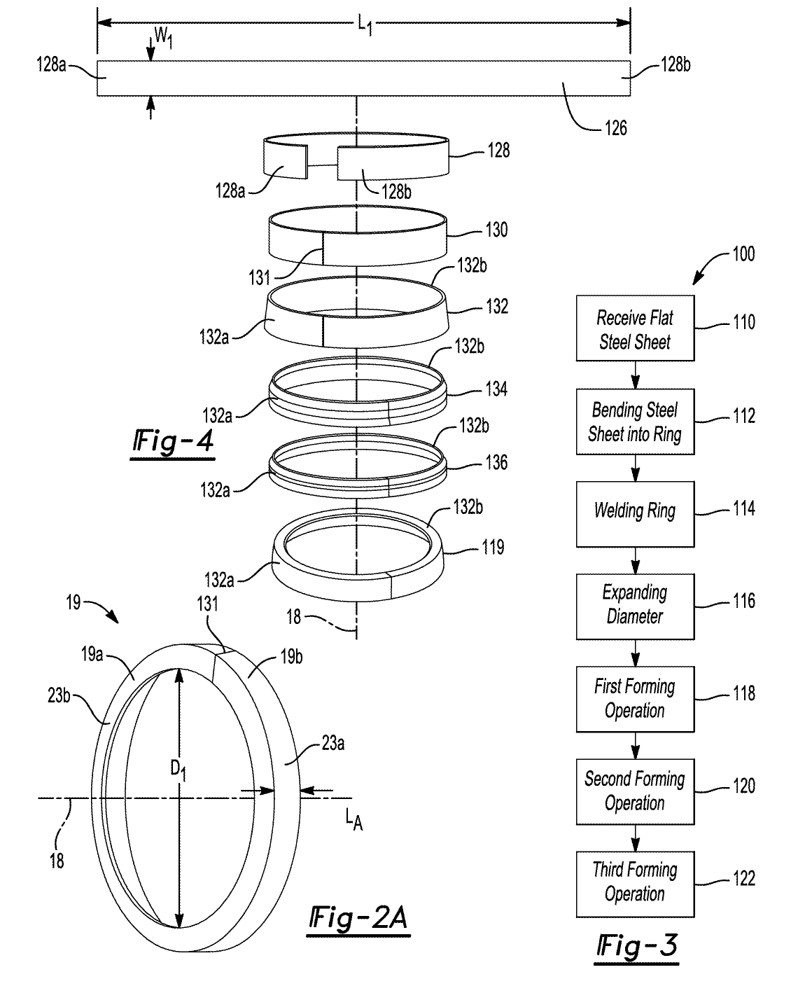

Referring to FIG. 2, an exploded view of the recliner assembly 16 is shown. The recliner assembly 16 may be configured to control pivoting of the seat back 14 about an axis 18 with respect to the seat bottom 12. For example, the recliner assembly 16 may facilitate pivoting of the seat back 14 between a folded position, in which the seat back 14 may be generally positioned over the seat bottom 12 through gear movements, and a reclined position. One or more recliner assemblies 16 may be provided with the seat assembly 10. For example, a pair of recliner assemblies 16 may be disposed along opposing lateral sides of the seat back 14 to selectively permit or inhibit pivoting of the seat back 14. A torsion rod may interconnect the recliner assemblies and synchronize operation of the recliner assemblies. The recliner assembly 16 may generally have a disc shape.

The recliner assembly 16 includes a recliner retention ring 19 and a recliner gear set 21. The gear set 21 may include a first plate 20, a second plate 22, a gear plate 24, a first cam 26, a second cam 28, a first set of pawls 30, a second set of pawls 32, one or more springs 34, a cam spacer 36, a first cam plate 38, a second cam plate 40, a spacer cam disc 42, a glide 46, and a cap 50. Operation of the recliner assembly 16 is described in U.S. Patent Publication No. 2015/0321585 and is hereby incorporated by reference.

Referring to FIG. 2A, a perspective view of the recliner retention ring 19 is provided. The retention ring 19 of the recliner assembly 16 is comprised of a metal member that is bent into an annular shape that includes a first end 19a connected to a second end 19b to form a band. The first end 19a and the second end 19b may be connected by a weld, such as a resistance weld 131. The retention ring includes a first portion 23a, that extends parallel to the axis 18, and a second portion 23b, that may also be referred to as a sidewall, that extends from and is orthogonal (e.g., perpendicular) to the first portion 23a. The second portion 23b may define a diameter D₁ that is sized to accommodate a portion of the second plate 22. The first portion 23a and the second portion 23b define a receptacle that receives the recliner gear set 21. More specifically, the first portion 23a defines an axial length LA that is adapted to or configured to enclose (e.g., surround or receive) the recliner gear set 21.

The retention ring 19 may be suitable for a discontinuous recliner, e.g., manual recliner, as illustrated, or a continuous recliner, e.g., power recliner or manual recliner. The metal member of the retention ring may be comprised of steel, aluminum, alloy, or any other suitable material. Note reference numeral 19 identifies the retention ring in FIG. 2 and FIG. 2A, but reference numerals 119, 219, and 319 correspond to the retention ring according to the first, second, and third embodiments of this disclosure. FIG. 3 through FIG. 8 depict possible methods of producing the recliner retention ring.

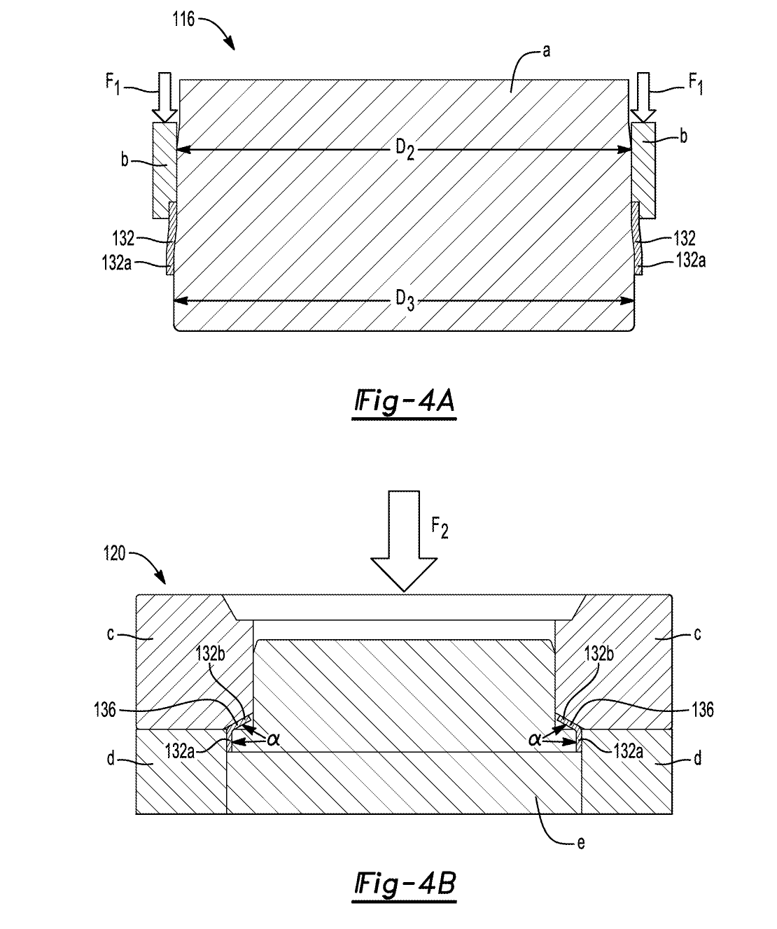

Referring to FIG. 3, a method of producing the retention ring 119 according to a first embodiment is illustrated, generally referred to by reference numeral 100. FIG. 4 is a progressive-perspective view of the retention ring 119 as it progresses through the operations or steps of the method 100. Operation 110 relates to receiving a flat metal sheet 126. The metal sheet may be stamped to a suitable width W₁ and length L₁ from a larger sheet or stamping blank. The metal sheet 126 has an elongated shape, meaning the length L₁ of the sheet 126 is greater than the width W₁ of the sheet 126. The steel sheet 126 includes a first end 128a and a second end 128b. Note, the terms “first” and “second” are interchangeable and are not intended to be limiting. The metal sheet 126 may be comprised of steel, aluminum, alloy or other suitable material.

Operation 112 relates to bending the steel sheet 126 into an annular shape to form a metal band 128, so that the first end 128a and the second end 128b are adjacent to or near one another. The term “bending” is used generally to encompass a folding process, or a roll forming process, or other suitable processes. Roll forming (e.g., roll bending or plate rolling) is a continuous bending operation in which the sheet of metal 126 is passed through a set of rolls until a desired cross-section profile, e.g., annular or circumferential shape is achieved. As another example, the steel sheet 126 may be bent by a press-brake that includes one or more dies and a press that forms the metal sheet 126 against the one or more dies.

Operation 114 relates to welding the first end 128a and the second end 128b of the band 128 together to form the welded band 130. One or more weld seams are represented by numeral 131. As one example, the first end 128a and the second end 128b may be connected by resistance welding (e.g., spot welding or seam welding). Resistance welding generally refers to generating a weld by the electrical resistance of the material (e.g., metal band 128) in combination with the time and force used to hold the first end 128a and the second end 128b together. Alternatively, the pair of ends 128a and 128b may be connected by another suitable welding process, such as gas metal arc welding (GMAW), gas tungsten arc welding (GTAW), or laser welding, among others.

Operation 116 relates to expanding the diameter of a first portion 132a of the welded band 130 relative to a second portion 132b of the welded band 130 to form a tapered band 132. Before expanding the diameter of the first portion 132a, the welded band 130 may generally have a uniform diameter that ranges between 65 mm and 85 mm. The diameter of first portion may be increased by 0.3 mm to 5 mm.

Referring specifically to FIG. 4A, a cross-sectional view of one example of executing operation 116 is illustrated. Operation 116 employs a die or a first tool “a” that includes a first section that defines a second diameter D₂ and a second section that defines larger third diameter D₃. Initially, the welded band 130 sits on a portion of the first tool “a”. A second tool “b” moves in the direction of the arrow F₁ to move the welded band 130 from the second diameter D₂ to the third diameter D₃ to increase the diameter of the first portion 132a. Upon increasing the diameter of the first portion, a tapered band 132 is formed. In another embodiment, the second tool “b” may be a clamp that fixes the position of the welded band 130 and the first tool “a” moves in a direction opposite to the direction indicated by directional arrow F₁. Either tool may be moved by a press, e.g., manual, hydraulic, pneumatic, etc.

Operations 118, 120, and 122 relate to first, second, and third forming operations, respectively. While three forming operations are shown, fewer or more forming operations may be employed. Operation 118 relates to the first forming operation, such as bending or flanging, of the second portion 132b of the tapered band 132 towards the central axis 18. More specifically, the second portion 132b is bent towards the central axis 18 relative to the first portion 132a by approximately 30° to form a receptacle-ring 134. Operations 120 and 122 relate to increasing the angle of the second portion 132b by increments of 30° until the second portion 132b forms a 90° or orthogonal angle with respect to the first portion 132a, respectively. The retention ring 119 is produced upon completion of operation 122.

Referring specifically to FIG. 4B, a cross-sectional view of one example of executing operation 120 is illustrated. Operation 120 may employ a first tool, such as a die “e,” that receives the band 134 (shown in FIG. 4) so that the tapered band 134 nests within a cavity defined by a second tool “d.” A third tool, such as a form “c,” moves in the direction of the arrow F₂ to bend the second portion 132b relative to the first portion 132a by an angle α. In another embodiment, the form “c” may be fixed, or held stationary, and the die “e” may move in the direction opposite to the arrow F₂.

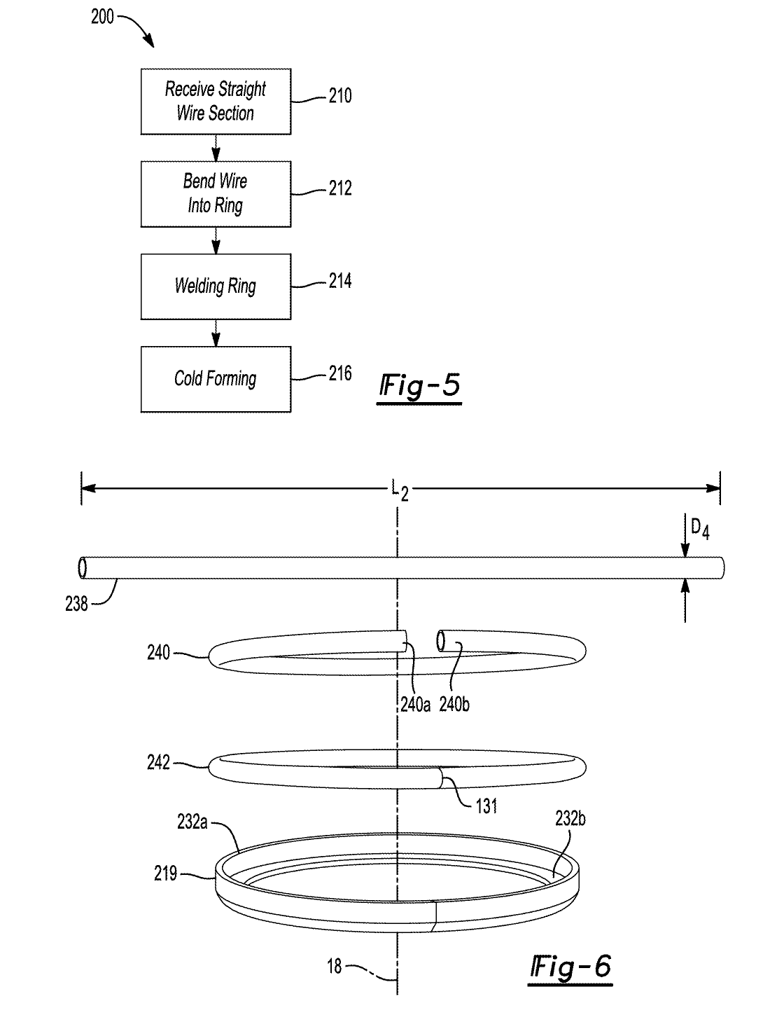

Referring to FIG. 5, a method of producing a retention ring 219 according to a second embodiment is illustrated, generally referred to by reference numeral 200. FIG. 6 is a progressive-perspective view of the retention ring 219 as it progresses through the operations of the method 200. Operation 210 relates to receiving a straight section of cylindrical wire 238. The cylindrical wire may define a first diameter D₄ (e.g., 4 mm) and be cut to an appropriate length L₂ (e.g., 293 mm) for subsequent operations. The diameter of the wire may range from 1 mm to 10 mm and the length of the wire may range from 260 mm to 320 mm. Additionally, the cylindrical wire may be coiled and later straightened before cutting the wire. The cylindrical wire 238 includes a first end 240a and a second end 240b.

Operation 212 relates to bending the straight wire 238 into a circumferential shape or band 240, so that the first end 240a and the second end 240b are adjacent to or near one another. Bending the straight wire 238 may be accomplished by various methods. For example, the wire may be bent by cold winding that includes winding the wire 238 around a shaft, such as a mandrel or arbor. As another example, a spring-wire machine may be employed to coil the wire. In yet another example, the wire may be bent or coiled by a central navigation computer (CNC) machine.

Operation 214 relates to welding the first end 240a and the second end 240b to one another band 240 to form the welded band 242. One or more weld seams are represented by numeral 131. As one example, the first end 240a and the second end 240b may be connected by resistance welding (e.g., spot welding or seam welding). Resistance welding generally refers to generating a weld by the electrical resistance of the material in combination with the time and force used to hold the first end 240a and the second end 240b together. Alternatively, the pair of ends 240a and 240b may be connected by another suitable welding process, such as gas metal arc welding (GMAW), gas tungsten arc welding (GTAW), or laser welding.

Operation 216 relates to cold forming the welded band 242 to form the desired shape of the retention ring 219. The process of cold forming involves forging metals at or near room temperatures. In cold forming, the metal is formed at a high speed and high pressure into tool steel or carbide dies. The cold forming process 216 forges the welded band 242 so that it defines a first portion 232a, that is parallel to the central axis 18, and a second portion 232b that is orthogonal to the first portion 232a. After the cold forming operation, the first portion 232a may have a thickness that is less than a thickness of the second portion 232b.

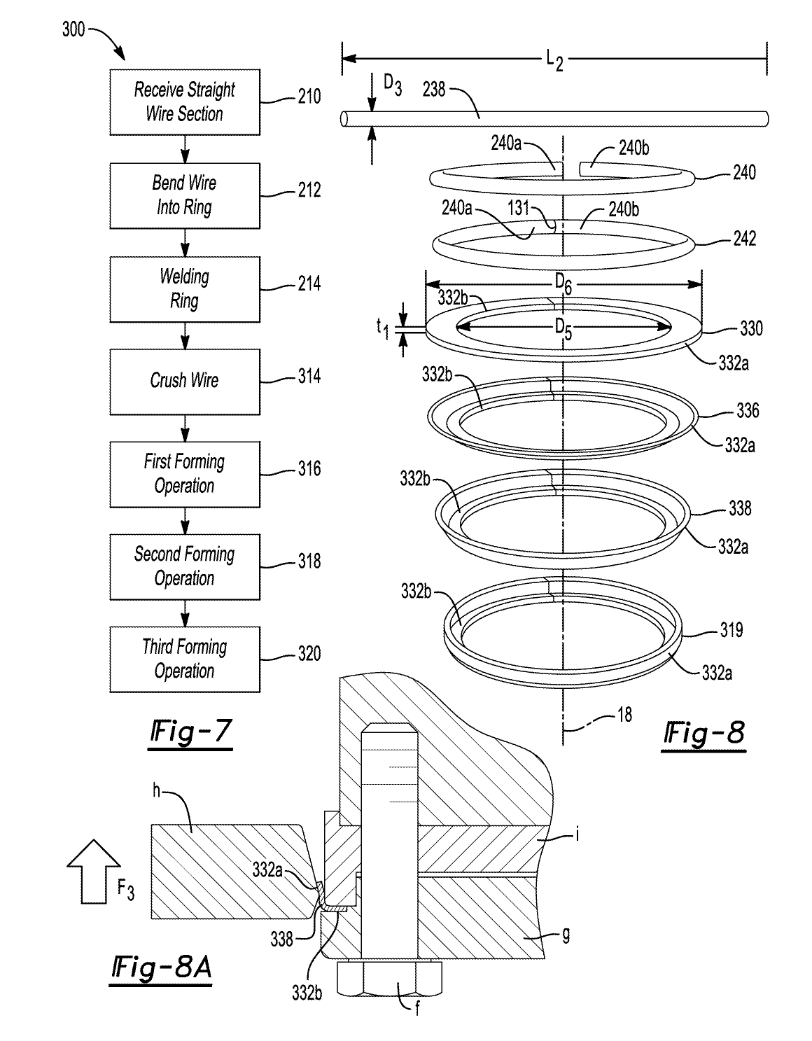

Referring to FIG. 7, a method of producing a retention ring 319 according to a third embodiment is illustrated, generally referred to by reference numeral 300. FIG. 8 is a progressive-perspective view of the retention ring 319 as it progresses through the operations of the method 300. Because the method 300 includes operations 210, 212, and 214, that are identical to those previously described above the description of those operations will not be duplicated.

Operation 314 relates to deforming or crushing the welded band 242 into a planar washer 330. Crushing the welded band 242 into the planar washer 330 may be accomplished by a stamping or pressing to deform or crush the welded band 242 into the planar shape illustrated. The planar washer 330 includes a first portion 332a that is defined by an outer periphery of the planar washer 330 and a second portion 332b that is defined by an inner periphery of the planar washer 330. The first portion 332a defines an outer diameter D₆ and the second portion 332b defines an inner diameter D₅. The planar washer 330 has a thickness of t₁ that is less than the difference between the outer diameter D₆ and the inner diameter D₅.

Operation 316 relates to the first forming operation, such as bending or flanging, of the first portion 332a towards the central axis 18 relative to the second portion 332b. More specifically, in operation 316 the first portion 332a is bent towards the second portion by approximately 30° to form a receptacle band 336. Operations 318 and 320 relate to increasing the angle of the first portion 332a by 60° and 90°, respectively. The retention ring 319 is produced upon completion of operation 122.

Referring specifically to FIG. 8A, a cross-sectional view of the forming operation 320 is illustrated. The operation 320 may employ a first tool, such as a clamp formed by a first jaw “g” and a second jaw “i” that engages the retention ring 319. A fastener “f” is threaded through the first jaw “g” and the second jaw “i” so that the clamp force applied to the retention ring 319 may be adjusted. The operation 320 may also include a forming tool “h” that moves in the direction of the arrow F₃ to bend the first portion 332a relative to the second portion 332b.

While exemplary embodiments are described above, it is not intended that these embodiments describe all possible forms according to the disclosure. Rather, the words used in the specification are words of description rather than limitation, and it is understood that various changes may be made without departing from the spirit and scope of the disclosure. Additionally, the features of various implementing embodiments may be combined to form further embodiments according to the disclosure.

1-8. (canceled)

9. A method of producing a recliner retention ring for use with a recliner assembly having a recliner gear set, the method comprising:
bending an elongated metal member, having a first end and a second end, into an annular shape; and
connecting the first end and the second end to one another to form a band that defines an inner periphery configured to receive the recliner gear set.

10. The method of claim 9, further comprising:
forming a first portion of the band towards a central axis of the band to define a sidewall after the connecting step.

11. The method of claim 10, wherein the step of forming the first portion to define the sidewall comprises cold forming the first portion.

12. The method of claim 10, wherein the step of forming the first portion includes nesting the band within a die and moving a tool along the central axis to flange the first portion.

13. The method of claim 12, further comprising:
expanding a second portion of the band, before the step of forming the first portion of the band, so that the second portion of the band defines a diameter that is greater than a diameter of the first portion.

14. The method of claim 13, further comprising:
straightening and cutting a section of round-cylindrical wire to a predetermined length to define the elongated metal member before the bending.

15. The method of claim 14, further comprising:
deforming the round-cylindrical wire into a planar washer that defines an inner diameter, an outer diameter, and a thickness, wherein a difference between the outer diameter and the inner diameter is greater than the thickness.

16. A recliner assembly for a vehicle seat including a seat base and a seat back, wherein the recliner assembly is configured to pivotally connect the seat back to the seat base, the recliner assembly comprising:
a retention ring formed by bending an elongated steel member into an annular shape having a first end and a second end, the retention ring further including a weld connecting the first end to the second end, wherein the retention ring includes a first portion and a second portion that extends inwardly from the first portion to define a receptacle; and
a recliner gear set received in the receptacle.

17. The recliner assembly of claim 16, wherein the first end and the second end are connected by a resistance weld.

18. (canceled)

19. The recliner assembly of claim 16, wherein the second portion is orthogonal to the first portion.

20. The recliner assembly of claim 19, wherein the first portion defines a first thickness and the second portion defines a second thickness greater than the first.

21. A method of making a recliner assembly for a seat assembly having a seat back and a seat bottom, the method comprising:
producing a recliner retention ring by bending an elongated metal member, having a first end and a second end, into an annular shape, and connecting the first end and the second end to one another to form a band that defines an inner periphery; and
positioning a recliner gear set within the inner periphery of the recliner retention ring;
wherein the recliner assembly is configured to facilitate pivoting of the seat back with respect to the seat bottom when the recliner assembly is mounted on the seat assembly.

22. The method of claim 21 wherein the recliner gear set includes a set of pawls.

23. The method of claim 22 wherein the recliner gear set further includes first and second plates, wherein the set of pawls is positioned between the first and second plates.

24. The method of claim 21 further comprising forming a first portion of the band towards a central axis of the band to define a sidewall after the connecting step.

25. The method of claim 24, wherein the step of forming the first portion to define the sidewall comprises cold forming the first portion.

26. The method of claim 24 further comprising expanding a second portion of the band, before the step of forming the first portion of the band and after the step of connecting the first end and the second end to one another, so that the second portion of the band defines a diameter that is greater than a diameter of the first portion, wherein the first and second portions define a receptacle for receiving the recliner gear set.

27. The method of claim 21 further comprising straightening and cutting a section of cylindrical wire to a predetermined length to define the elongated metal member before the bending.

28. The method of claim 27 further comprising deforming the cylindrical wire into a planar washer that defines an inner diameter, an outer diameter, and a thickness, wherein a difference between the outer diameter and the inner diameter is greater than the thickness.

29. The method of claim 27 further comprising forming a first portion of the band towards a central axis of the band to define a sidewall after the connecting step, wherein the first portion of the band cooperates with an axially extending second portion of the band to define a receptacle, the positioning step comprises positioning the recliner gear set in the receptacle, and the recliner gear set includes first and second plates and a set of pawls positioned between the first and second plates.
